(19) United States
(12) Patent Application Publication
(10) Pub. No.: US 2015/0019875 A1
(43) Pub. Date: Jan. 15, 2015

(54) PORTABLE DEVICE FOR DATA ENCRYPTION/DECRYPTION AND/OR COMPRESSION/DECOMPRESSION

(71) Applicant: QUANTEC SA, Chiasso (CH)

(72) Inventors: Michele Barbiero, Paradiso-Lugano (CH); Pierluigi Pentimalli, Chiasso (CH)

(73) Assignee: QUANTEC SA, Chiasso (CH)

(21) Appl. No.: 14/378,744

(22) PCT Filed: Feb. 15, 2013
(86) PCT No.: PCT/IB2013/000200

§ 371 Date: Aug. 14, 2014

(30) Foreign Application Priority Data
Feb. 17, 2012 (FR) 00212/12

(51) Int. Cl. G06F 21/60; G06F 13/16; G06F 13/40

(52) U.S. Cl. CPC G06F 21/602; G06F 13/4068; G06F 13/16
USPC 713/189

(57) ABSTRACT

Portable integrated device (100) for data encryption/decryption and/or compression/decompression including: an outer casing (2); at least one authentication support cryptographic chip (4); at least one first data input/output port (5) adapted to be interfaced with external devices; at least one second data input/output port (6) adapted to be interfaced with external devices; at least one main chip including at least one CPU (3); the CPU (3) including: at least one microprocessor or microcontroller; and at least one cryptographic engine.

### FIELD OF THE INVENTION

The present invention relates to the field of data encryption and/or compression and particularly to a portable integrated device for data encryption/decryption and/or compression/decompression.

### PRIOR ART

In the field of data encryption both software and hardware solutions are available on the market.

Software solutions usually envisage that the user performs on the average at least two distinct operations, or even more, with systems different from each other for being able to ensure a secure information exchange.

Considering for example the case of a user who has to send privileged contents to third parties known to her/him and thus wishes to encrypt such data and information (this case can be extended in a 1:1-fashion also to compression), the user will have to, in sequence:
encrypt the information he wishes to send;
memorize the encrypted information on her/his system (computer, PC, etc.);
send the encrypted information to the addressee(s) by means of another system (e-mail, web transfer by means of third parties systems, Skype, MSN, peer-to-peer systems, physical shipping of a mass memory device, e.g. a CD Rom, a USB stick, a USB Hard Disk, etc.)
let the addressee(s) know the encryption key through a channel different from that used for sending the data themselves (action which is per se not secure).

A this point the recipient of the encrypted data has to perform exactly the reverse actions and the procedure clearly depends on the software system used for encryption, as well as on the method used to send the encrypted information.

The Applicant has further noted that the software solution suffers from a big limitation which is common to all of the solutions present on the market: the encryption key by which the information has been encrypted “travels” totally or partially together with the encrypted information itself.

Among other things, these software solutions are often open-source and, thus, even if the key is “shadowed” in the file itself by means of appropriate algorithms, it is relatively simple to retrieve it in a few hours' work.

The Applicant has further noted that even if the encryption key were not “travelling” together with the encrypted data and information, the software solution would be easily exposed to attempts of memory dumping, snooping, spoofing and generally of intercepting the key itself. This is possible by means of appropriate programs, such as trojans and malware in general, keylogger, etc., which create a “backdoor” in the user's computer, thus intercepting the entries made by means of a keyboard or by a mouse “click”, and even performing, by means of the “memory dumping” technique, the analysis of the encryption keys and of the critical information of the cryptographic algorithms directly in the computer's memory, i.e. directly in the execution space of the software solution itself.

In view of the above, the Applicant has perceived that the known software solutions are thus inherently not secure and, in addition, require a certain ability to work with a computer.

On the market there are further available some hardware solutions.

Generally, these solutions consist, in the vast majority of the cases, of USB devices (totally similar to a USB stick) internally provided with a local mass memory (like, indeed, common storage USB sticks) and only in some cases with cryptographic chips. These solutions substantially allow the device to be plugged into a computer (exclusively by means of the USB interface) and data and file to be written and red on/from the integrated storage memory in a secure manner: the data are encrypted and decrypted in real time.

The Applicant has however observed that these devices are not internally provided with a microprocessor, but at most with a microcontroller, and thus have a limited computing capacity and are not able to update “on board” services, such as encryption and/or compression algorithms more recent than those for which they were designed, in the course of time.

Moreover, like with the software solution, when a user needs to send to privileged contents to third parties known to her/him, she/he has in any case to send the USB stick containing the data encrypted by means of another system, thus facing again the abovementioned problems.

The Applicant has thus felt the need to provide a device for data encryption/decryption and compression/decompression which has a simple structure, is secure and allows overcoming the abovementioned problems of the known solutions.

### SUMMARY OF THE INVENTION

Therefore, in a first aspect thereof, the invention relates to a portable integrated device for data encryption/decryption and/or compression/decompression comprising:
an outer casing;
at least one authentication support cryptographic chip;
at least one first data input/output port adapted to be interfaced with external devices;
at least one second data input/output port adapted to be interfaced with external devices;
at least one main chip comprising at least one CPU; said CPU comprising:
at least one microprocessor or microcontroller; and
at least one cryptographic engine.

Within the framework of the present invention, by the term chip it is meant a highly integrated electronic circuit.

Within the framework of the present invention, by integrated device it is meant an assembly of electronic semiconductors, chips, connectors and casing suitable to perform the required functions.

The present invention, in the abovementioned aspect, may have at least one of the preferred features hereinafter described.

Preferably, the authentication support cryptographic chip comprises a random numbers generator, at least one cryptographic hashing engine and at least one protected memory, dedicated to data security tasks.

Preferably, the authentication support cryptographic chip is configured for generating encryption keys.

Advantageously, the authentication support cryptographic chip generates high entropy univocal encryption keys.

Preferably, the authentication support cryptographic chip is integrated with said main chip.

Preferably, the authentication support cryptographic chip is able to memorize trade secrets, in a protected way.

Within the framework of the present invention, by the term microcontroller it is meant a controller generally operating at 100/150 MHz, with addressing capacity up to 32 bits, and having a series of peripheral units and system elements (in this case referred to as “on board” systems and peripheral units) directly on the chip forming the controller. The microcontrollers are further able to execute the native code or programs within the RTOS framework.

Within the framework of the present invention, by the term microprocessor it is meant a controller generally operating at frequencies higher than 150/200 MHz, with addressing capacity higher than 16 bits, and having a series of peripheral units and system elements which are external to the chip, i.e. not on board. Differently from a microcontroller, a microprocessor is able to execute full operating systems, such as Linux or Microsoft Windows Embedded.

Preferably, the CPU comprises a microprocessor.

Advantageously, the microprocessor has an addressing capacity greater than 32 bits, preferably greater than 40 bits.

Advantageously, the first data input/output port and the second data input/output port comprise connection members suitable for communicating data to external devices according to an international communication standard selected from Ethernet, USB, Firewire, ThunderBolt, Bluetooth, Wi-Fi, UWB, ZigBee, ANT, WirelessHART, SATA, PATA, EIDE, RS232, RS485, CAN, Lin, Profibus or an analog audio connection member (such as headset and/or microphone connectors).

Conveniently, the first data input/output port comprises a male is connection member adapted to be interfaced with a female connection member of a first external device

Within the framework of the present invention, by connection member it is meant an electromechanical member which is able to allow an operating association with a further connection member.

Within the framework of the present invention, by male connection member it is meant a connection member adapted to be at least partially introduced in a recess representing a female connection member.

Within the framework of the present invention, by female connection member it is meant a connection member adapted to at least partially receive a male connection member.

Preferably, the second data input/output port comprises a female connection member adapted to be interfaced with a male connection member of a second external device.

Conveniently, the first data input/output port comprises a USB male connection.

Preferably, the second data input/output port comprises a female USB connection member.

Advantageously, the first and second external devices are selected from personal computers, Notebooks, Netbooks, Desktops, Workstations, Servers, Palmtops and hand-held devices, Tablets, Smartphones, mobile phones, USB storage devices, Keyboard, mouse, digital and analog Headset, Modem, Router, Gateway.

Conveniently, the authentication support cryptographic chip is configured to for:
performing a mutual authentication between said first external device interfaced with said first port and the portable device and/or between the portable device and the second external device interfaced with said second port;
establishing a secure connection between said portable device and a first external device and/or a second external device (18).

The authentication support cryptographic chip is also configured for:
performing a mutual authentication between said first external device interfaced with said first port and the portable integrated device and between the portable integrated device and a further portable integrated device according to the present invention interfaced with said second port;
establishing a secure connection between said portable integrated device and a first external device and/or a second portable integrated device according to the present invention.

The authentication support cryptographic chip is also configured for establishing a secure connection, by means of a PAN, LAN, WAN, Internet network, with server systems for managing functions of the portable integrated device itself.

Preferably, the portable integrated device comprises at least one RAM memory of the dynamic type.

Conveniently, the portable integrated device comprises at least one memory of the flash type.

Preferably, the portable integrated device comprises at least one system for supplying power to at least the CPU and at least the second data input/output port.

Advantageously, the casing has a longitudinal extension L≦15 cm.

Preferably, the portable integrated device has a weight of between 0.01 kg and 3 kg.

Conveniently, the portable integrated device comprises a Bluetooth communication module.

Advantageously, the portable integrated device according to the present invention comprises a memory expansion module.

According to another aspect thereof, the present invention relates to a process for exchanging data in a secure way between two external devices interfaced with a portable device as mentioned above. The process comprises the steps of:
connecting a female connection member of a data input/output port of a first external device with a male connection member of said first data input/output port of said portable device;
connecting a male connection member of a data input/output port of a second external device with a female connection member of said second data input/output port of said portable device;
checking a first identification parameter (VID) of the first external device for determining the device manufacturer;
recognizing the type of first external device connected with said device by means of a second identification parameter (PID).

Advantageously, the process further comprises the steps of:
performing a mutual authentication between the first external device and the portable device and between the portable device and the second external device;
establishing a secure connection between the first external device and the second external device.

Alternatively, the process comprises the steps of:
performing a mutual authentication between the first external device and the portable device and between the portable device and the second external device;
mapping the second external device to the first external device;
encrypting/decrypting and/or compressing/decompressing by means of the cryptographic engine of the CPU.

According to an another alternative, the process comprises the steps of:
performing a mutual authentication between the first external device and the portable device and between the portable device and the second external device;
acquiring, by means of the portable device, the analog and/or digital audio stream sent by the second external device;
encoding/decoding the said stream by means of a codec executed by the CPU;
encrypting/decrypting and/or compressing/decompressing by means of the cryptographic engine of the CPU.

### BRIEF DESCRIPTION OF THE DRAWINGS

Further features and advantages of the invention will become more apparent from the detailed description of some preferred, although not exclusive, embodiments of a portable device for data encryption/decryption and/or compression/decompression according to the present invention.

Such description will be presented hereinafter with reference to the accompanying drawings, provided only for indicating, and thus non-limiting, purposes, wherein:

FIG. 1 is a schematic view of a portable device for data encryption/decryption and/or compression/decompression according to the present invention;

FIG. 2 is a block diagram of an embodiment of an hardware configuration of a portable device for data encryption/decryption and/or compression/decompression according to the present invention.

FIG. 3 is a block diagram of a function of the portable device for data encryption/decryption and/or compression/decompression according to the present invention.

### DETAILED DESCRIPTION OF PREFERRED EMBODIMENTS OF THE INVENTION

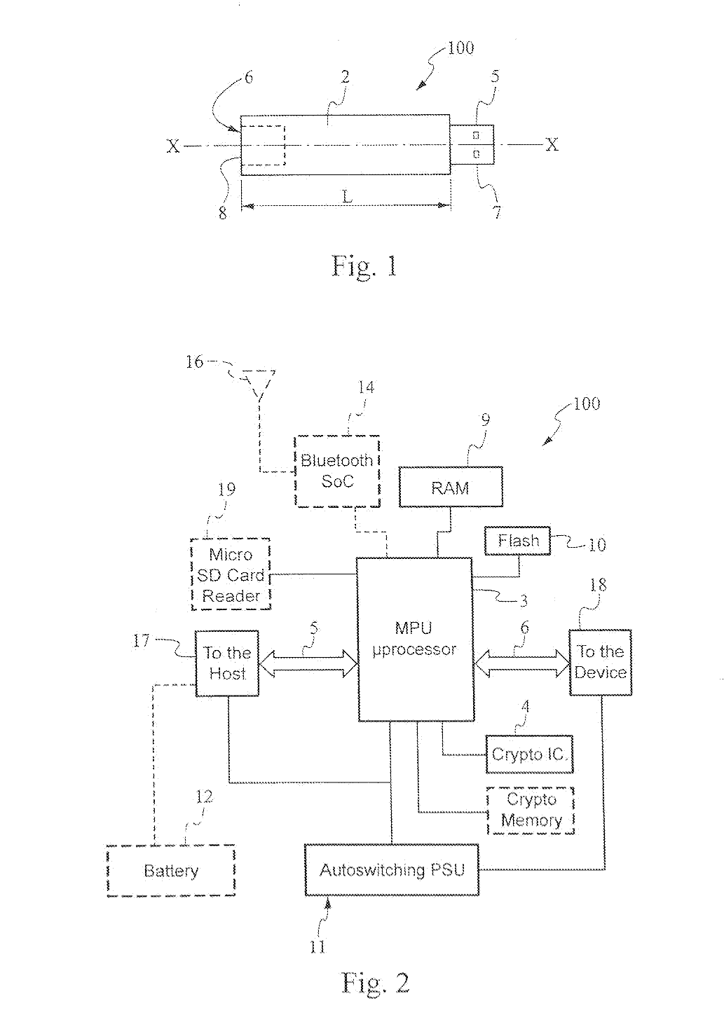

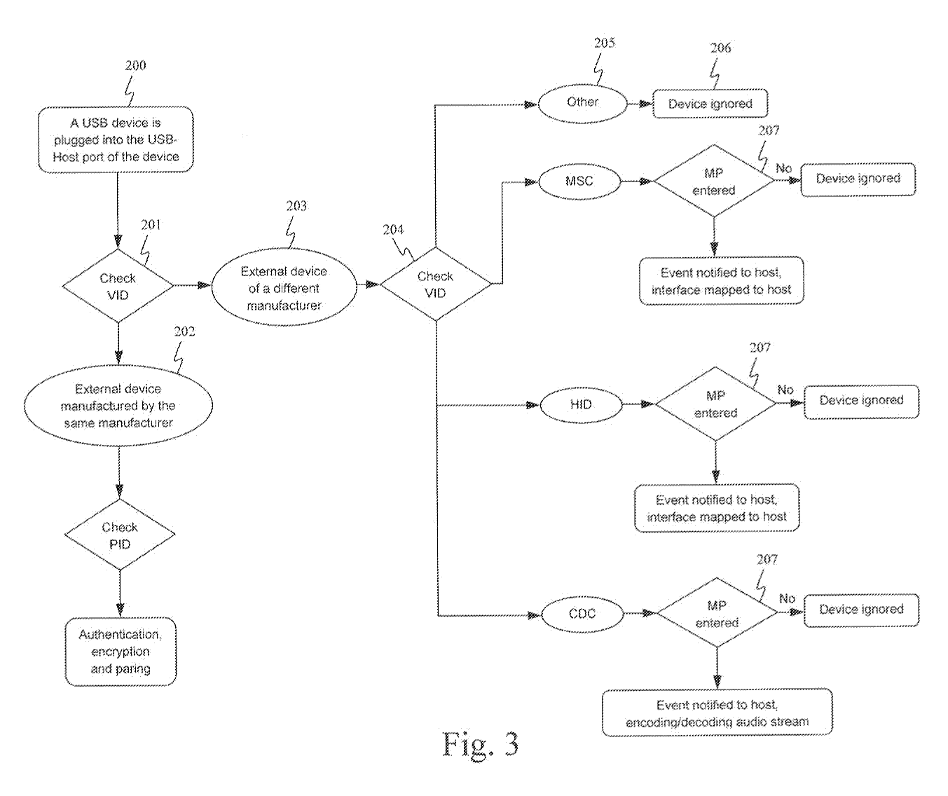

Referring to FIGS. 1-3, a portable device for data encryption/decryption and/or compression/decompression according to the present invention is identified by reference numeral 100.

The device 100, in the embodiment shown in FIG. 1, has an outer casing 2, at least one authentication support cryptographic chip 4, at least one first data input/output port 5 adapted to be interfaced with external devices, and at least one second data input/output port 6 adapted to be interfaced with external devices, at least one main chip comprising at least one CPU 3. The outer casing preferably extends along a main direction so as to define an extension direction X-X. In the embodiment schematically shown in FIG. 1, the first and the second data input/output ports 5, 6 are located at opposite ends of the casing 2 relative to the extension direction.

Conveniently, the first data input/output port 5 comprises a USB male connection member.

Preferably, the second data input/output port 6 comprises a USB female connection member.

Preferably, in order to make the device easily portable, the casing 2 has a substantially parallelepiped shape and a longitudinal extension L, with L≦15 cm, even more preferably L≦10 cm.

The casing 2 contains in its interior at least one main chip comprising a CPU 3 and at least the authentication support cryptographic chip 4, hereinafter described in more detail.

The CPU 3 comprises at least one microprocessor, at least one cryptographic engine and/or at least one compression/decompression engine. According to an embodiment, the microprocessor is a 32-bit CISC/RISC microprocessor and has a computing power up to 720 MHz; the cryptographic engine is a cryptographic engine of the hardware type, suitable for managing algorithms of the type RSA and AES in its variants, 3DES, as well as hashing algorithms of the type MD5, SHA-1, SHA-256.

The CPU 3 is functionally connected with the authentication cryptographic chip 4.

The authentication cryptographic chip 4 comprises a microcontroller exclusively dedicated to tasks connected with data security.

The authentication cryptographic chip 4 comprises a random numbers generator of the TRNG type, at least one cryptographic hashing engine and at least one protected memory comprising circuits adapted to prevent unauthorized persons from reading data from outside the device 100 and/or appropriate metal shielding against intrusive analysis and weak currents.

The authentication cryptographic chip 4, besides performing the functions of random numbers generation and Hash functions computation, is configured for validating the presence of a common data item inside two devices, for example the device 100 according to the present invention and an external device, without needing to exchange the data item itself between the two devices.

The authentication cryptographic chip is further configured for obtaining, in a univocal and secure way, from secret encrypted keys further keys and/or codes which are then used by the cryptographic algorithms in the CPU.

The authentication cryptographic chip 4 preferably belongs to the TPM (Trusted Platform Module) platform.

The device 100 further comprises, inside the enclosure, at least one RAM memory 9 of the dynamic type and at least one memory 10 of the flash type.

According to an embodiment, the memory 10 of the flash type is a 128 Mbit or larger flash memory; part of the bootloader, the operating system, the applications and data reside in this memory.

According to an embodiment, the device 100 may contain a Bluetooth communication module 14. The Bluetooth communication module 14, according to an embodiment, comprises a microcontroller placed in a System in Chip (SoC) dedicated to the management of Bluetooth connections through a radio interface with external devices comprising corresponding Bluetooth modules. The radio interface comprises at least one receiving/transmitting antenna 16.

The device 100 further comprises a memory expansion module 19, not shown in the figure. Preferably, the memory expansion module can vary the memorization capacity. To this end, advantageously, the memory expansion module comprises a Micro SD card reader.

The device 100 further comprises at least one system 11 for supplying power to at least the CPU 3 and at least the second data input/output port 8.

The system for supplying power comprises at least one highly integrated chip and the related support electronic circuitry and can be functionally connected with at least one power supply external to the device 100, such as for example a rechargeable battery, a replaceable battery or a condenser or power supply subsystem of the external device itself, provided in one of the external devices connected to said device 100 through the first or second port.

In some embodiments, the battery or the condenser may recharged by one of the external devices, particularly by the external device into which the male connector of the device 100 is plugged and with which the same is connected. In this case, an automatic switch adapted to exclude the battery 12 may be present.

Also to the end of allowing easy transport and handling of the device 100, the latter has a weight of between 0.01 kg and 3 kg. Preferably, of between 0.02 and 1 kg.

The device 100 according to the present invention thus allows two external devices connected with each other to communicate with each other in a secure way and via hardware, by means of a physical passage of data within the device itself.

During normal operation or upon switching on (plugging of the device 100 into a first external device 17), the CPU 3 of the device 100 constantly checks the possible plugging of a second external device 18 into its second data input/output port 6.

In detail, the CPU 3 checks whether a connection member of the male type, such as for example a male USB connector, is plugged into the female connection member 8 of its second data input/output port 6.

Each time the CPU detects that the male connection member of a new external device 18 is plugged into the female connection member 8 of the second data input/output port 6 of the device 100, the event is managed based on the type of device 18 which has been plugged in.

In FIG. 3 a flow diagram is represented which shows how the CPU 3 reacts when, as indicated at reference numeral 200, it is detected that a second external device 18 plugs its male connection member into the second data input/output port 6 of the device 100 according to the present invention.

At 201 it is determined the manufacturer of the device 18 whose male connection member has been plugged into the female connection member 8 of the second data input/output port 8.

The device 18 sends to the CPU 3 a first identification parameter (VID) which identifies the manufacturer of said device 18.

The CPU further discriminates between a second external device 18 manufactured by the same manufacturer of the device 100 according to the present invention, reference numeral 202, and a device of a different manufacturer, reference numeral 203. This operation is performed by comparing the first identification parameter (VID) sent by said second device with a reference identification parameter (that of the manufacturer of the device 100) stored in the memory of the flash type.

In the case in which the first identification parameter (VID) does not correspond to the identification parameter of the manufacturer of the device 100 according to the present invention, event indicated at reference numeral 203, the CPU 3 gets ready to identify the type of second device. To this end, at 204, if the second external device is not manufactured by the same manufacturer of the device 100, the CPU discriminates by means of a second identification parameter (PID) the type of second external device 18.

This operation is performed by comparing the second identification parameter (PID) sent by said second device 18 with a library of second identification parameters stored in the memory of the flash type.

If the second device is not a device of the HID or MSC or CDC type the process ends and the second device is ignored, blocks 205, 206.

If the second device is a HID or MSC or CDC device, such as a keyboard, a USB headset or a mass storage device, the CPU 3 invites the user who has plugged in the second device 18 to enter a predetermined user code of the alphanumeric type, i.e. a “Master Password”.

If the user enters the right user code, block 207, the process goes on and a message is sent to the first device 17 informing the same that the second device 18 is present and that access has been authorized, and the interface is then mapped to the first device 17. In other words, the first device 17 is able to exchange information with the second device 18 as if the first and second device were “virtually” directly interfaced.

As data are exchanged between the first device 17 and the second device 18, these can be at least partially encrypted/decrypted and/or compressed/decompressed by the cryptographic engine of the CPU 3.

At 207, if the user does not enter the predetermined identification code or enters a wrong code for a determined number of times, the process ends, the second device is ignored and the device 100 will be blocked.

At 207, if a predetermined user code of the alphanumeric type, i.e. the “Master Password”, was previously provided, the process goes directly to the step in which a message is sent to the first device 17 informing the same that the second device 18 is present and access has been authorized, and the interface is then mapped to the first device 17.

In particular, if the second device is a CDC device, such as an analog and/or digital headset, the CPU 3 asks the user who has plugged in the second device 18 to enter a predetermined user code of the alphanumerical type, i.e. a “Master Password”.

If the user enters the correct user code, block 207, the process goes on and a message is sent to the first device 17 informing the same that the second device 18 is present and access has be authorized.

At this point, the portable device 100 acquires the analog and/or digital audio stream sent by the second external device 18.

The CPU 3 then provides for the encoding and/or decoding of said stream by executing a codec.

The encryption/decryption and/or compression/decompression is then performed by the CPU.

If the first identification parameter (VID) corresponds to that of the manufacturer of the device 100 according to the present invention, the CPU gets ready to identify the type of the second device.

In a way similar to what has been done for devices not manufactured by the same manufacturer of the device 100, at 202 the CPU 3 discriminates, by means of a second identification parameter PID, the type of second external device.

This operation is performed by comparing the second identification parameter (PID) sent by said second device 18 with a library of second identification parameters contained in the memory 10 of the flash type.

At this point, a step of mutual authentication between the device 100 according to the present invention and the second device 18 takes place, at the end of which a secure connection between the device 100 according to the present invention and the second device 18 is established.

The secure connection takes place by means of the authentication cryptographic chip 4 of the device 100 according to the present invention, which is configured for obtaining, in a univocal and secure way, from secret encrypted is keys further keys and/or codes which are then used by the cryptographic algorithms in the CPU.

Once the secure connection has been established it is possible to execute services provided by the second external device 18, such as for example backup or restore of data stored in the device 100 according to the present invention. The data exchanged between the second external device 18 and the portable device 100 according to the present invention are thus exchanged in an intrinsically secure way.

By way of example, it is specified that the integrated device 100 according to the present invention is configured, by means of the authentication cryptographic chip 4, preferably of the TPM platform, so as to be able to exchange in a secure way cryptographic keys between different user, in fact creating its own secure sharing network.

This can occur either by physically associating two portable integrated devices 100 according to the present invention, wherein the first portable integrated device has its second port 6 interfaced with the first port of the second portable integrated device 100 according to the present invention, or by means of remote connection, e.g. by means of a PAN, LAN, WAN, Internet connection, between the two portable integrated devices according to the present invention.

The present invention has been described with reference to some embodiments thereof. Many modifications can be introduced in the embodiments described in detail, still remaining within the scope of protection of the invention, defined by the appended claims.

1. Portable integrated device (100) for data encryption/decryption and/or compression/decompression comprising:
an outer casing (2);
at least one authentication support cryptographic chip (4);
at least one first data input/output port (5) adapted to be interfaced with external devices;
at least one second data input/output port (6) adapted to be interfaced with external devices;
at least one main chip comprising at least one CPU (3);
said CPU (3) comprising:
at least one microprocessor or microcontroller; and
at least one cryptographic engine.

2. Portable integrated device (100) for data encryption/decryption and/or compression/decompression according to claim 1, characterized in that said authentication support cryptographic chip (4) comprises a random numbers generator, at least one cryptographic hashing engine and at least one protected memory, dedicated to data security tasks.

3. Portable integrated device (100) for data encryption/decryption and/or compression/decompression according to claim 1, characterized in that said first data input/output port (5) and said second data input/output port (6) comprise connection members suitable for communicating data to external devices according to an international communication standard selected from Ethernet, USB, Firewire, ThunderBolt, Bluetooth, Wi-Fi, UWB, ZigBee, ANT, WirelessHART, SATA, PATA, EIDE, RS232, RS485, CAN, Lin, Profibus and/or an analog audio connection member.

4. Portable integrated device (100) for data encryption/decryption and/or compression/decompression according to claim 1, characterized in that said first data input/output port (5) comprises a male connection member (7) adapted to be interfaced with a female connection member of a first external device (17) and in that said second data input/output port (6) comprises a female connection member (8) adapted to be interfaced with a male connection member of a second external device (18).

5. Portable integrated device (100) for data encryption/decryption and/or compression/decompression according to claim 1, characterized in that said first data input/output port comprises a USB male connection.

6. Portable integrated device (100) for data encryption/decryption and/or compression/decompression according to claim 1, characterized in that said first (17) and second (18) external devices are selected from personal computer, Notebook, Netbook, Desktop, Workstation, Server, Palmtop and hand-held device, Tablet, Smartphones, mobile phones, USB storage devices, Keyboard, mouse, digital and analog Headset, Modem, Router, Gateway.

7. Portable integrated device (100) for data encryption/decryption and/or compression/decompression according to claim 1, characterized in that said authentication support cryptographic chip (4) is configured for:
performing a mutual authentication between said first external device (17) interfaced with said first port (5) and the portable device (100) and/or between the portable device (100) and the second external device (18) interfaced with said second port (6);
establishing a secure connection between said portable device (100) and a first external device (17) and/or a second external device (18).

8. Portable integrated device (100) for data encryption/decryption and/or compression/decompression according to claim 1, characterized by comprising at least one RAM memory (9) of the dynamic type.

9. Portable integrated device (100) for data encryption/decryption and/or compression/decompression according to claim 1, characterized by comprising at least one memory (10) of the flash type.

10. Portable integrated device (100) for data encryption/decryption and/or compression/decompression according to claim 1, characterized by comprising at least one system (11) for supply power to at least said CPU (3) and at least said second data input/output port (6).

11. Portable integrated device (100) for data encryption/decryption and/or compression/decompression according to claim 1, characterized in that said casing (2) has a longitudinal extension L≦15 cm.

12. Portable integrated device (100) for data encryption/decryption and/or compression/decompression according to claim 1, characterized in that said device has a weight of between 0.01 kg and 3 kg.

13. Portable integrated device (100) for data encryption/decryption and/or compression/decompression according to claim 1, characterized by comprising a Bluetooth communication module (14).

14. Portable integrated device (100) for data encryption/decryption and/or compression/decompression according to claim 1, characterized by comprising a memory expansion module (19).

15. Process of communication between a first and a second external devices (17, 18) and a portable device (100) according to claim 1;
said first external device (17) comprising at least one female connection member and said second external device (18) comprising at least one male connection member;
said process comprising the steps of:
connecting a female connection member of a data input/output port of a first external device (17) with a male connection member (7) of said first data input/output port (5) of said portable device (100);
connecting a male connection member of a data input/output port of a second external device (18) with a female connection member (8) of said second data input/output port (6) of said portable device (100);
checking a first identification parameter (VID) of the second external device (18) for determining the device manufacturer;
recognizing the type of second external device (18) connected with said device (100) by means of a second identification parameter (PID).

16. Process according to claim 15, characterized by comprising the steps of:
performing a mutual authentication between the first external device (17) and the portable device (100) and between the portable device (100) and the second external device (18);
establishing a secure connection between said portable device (100) and said second external device (18).

17. Process according to claim 15, characterized by comprising the steps of:
performing a mutual authentication between the first external device and the portable device (100) and between the portable device (100) and the second external device;
mapping the second external device (18) to the first external device (17);
encrypting/decrypting and/or compressing/decompressing by means of the cryptographic engine of the CPU (3).

18. Portable integrated device (100) for data encryption/decryption and/or compression/decompression according to claim 2, characterized in that said first data input/output port (5) and said second data input/output port (6) comprise connection members suitable for communicating data to external devices according to an international communication standard selected from Ethernet, USB, Firewire, ThunderBolt, Bluetooth, Wi-Fi, UWB, ZigBee, ANT, WirelessHART, SATA, PATA, EIDE, RS232, RS485, CAN, Lin, Profibus and/or an analog audio connection member.
